(19) United States
(12) Patent Application Publication
(10) Pub. No.: US 2014/0127928 A1
(43) Pub. Date: May 8, 2014

(54) CONNECTOR

(71) Applicant: Sumitomo Wiring Systems, Ltd., Yokkaichi-City (JP)

(72) Inventor: Shinjiro Kida, Yokkaichi-City (JP)

(73) Assignee: Sumitomo Wiring Systems, Ltd., Yokkaichi-City (JP)

(21) Appl. No.: 14/070,902

(22) Filed: Nov. 4, 2013

(30) Foreign Application Priority Data
Nov. 5, 2012 (JP) 2012-243664

(51) Int. Cl. H01R 13/62

(52) U.S. Cl. CPC H01R 13/62
USPC 439/345

(57) ABSTRACT

A retainer-side guiding surface (47) for guiding a tab (101) of a mating terminal fitting (100) is widened on a side that covers a locking lance (19) from the front, at an opening edge of each tab insertion hole (45) on a front wall (41) of a front retainer (40). A housing-side guiding surface (33) for guiding the tab (101) is widened at positions facing the inside of the tab insertion hole (45) except at a position facing the one side part at an opening edge of each cavity (18) on the front surface of the housing (10). Lock receiving portions for retaining the retainer are formed on a partition wall (23) between adjacent cavities (18) in the housing (10). The lock receiving portions are located behind the housing-side guiding surfaces (33) and include parts overlapping the retainer-side guiding surfaces (47) in a height direction of the partition wall (23).

### BACKGROUND

1. Field of the Invention

The invention relates to a connector.

2. Description of the Related Art

Japanese Unexamined Patent Publication No. 2011-34882 discloses a connector with a housing that includes a plurality of cavities. Terminal fittings are inserted into the cavities. A deflectable locking lance projects forward at an inner surface of each cavity and engages a properly inserted terminal fitting. A front retainer is assembled with the housing. The retainer is configured to cover the front surface of the housing and includes a front wall with tab insertion holes at positions facing the respective cavities. Retaining portions project back from the retainer at positions corresponding to the respective cavities. A properly inserted terminal fitting is retained primarily by the locking lance and secondarily by the entrance of the retaining portion into a deformation space for the locking lance as the front retainer is assembled.

A retainer-side guiding surface is widened on an upper side of an opening of each tab insertion hole on a part of the front surface of the front wall that covers the locking lance from front when the front retainer is assembled. Further, a housing-side guiding surface is widened at an opening of each cavity on the front surface of the housing and at positions facing the inside of the tab insertion hole except at a position facing the upper side. When the front retainer is assembled with the housing, the retainer-side guiding surface and the housing-side guiding surface are connected in a circumferential direction to guide a tab of a mating terminal fitting inserted from the front. Further, omitting the housing-side guiding surface from an upper part of the front end of each cavity of the housing, reduces the height of the connector and improves molding since it is not necessary to form a thin wall at the upper part of the front end of each cavity.

A lock receiving portion can be formed on a partition wall between adjacent cavities and can engage a lock of the front retainer to prevent forward detachment of the front retainer. However, the height of the partition wall is reduced if the wall is omitted from the upper part of the front end of each cavity. Thus, a sufficient formation area for the lock receiving portion cannot be ensured and a locking margin between the lock receiving portion and the lock is reduced to reduce a holding force for the front retainer.

The invention was completed in view of the above situation and aims to reduce the height of the housing and maintain holding reliability for a front retainer.

### SUMMARY OF THE INVENTION

The invention relates to a connector with a housing that has cavities for receiving terminal fittings. Locking lances project from inner surfaces of the respective cavities for primarily retaining the terminal fittings and a lock receiving portion is formed on a partition wall between adjacent cavities. A front retainer is assembled with the housing and has a front wall that covers the front surface of the housing. Tab insertion holes penetrate the front wall of the retainer at positions facing the respective cavities. Retaining portions project rearward from the front wall for secondarily retaining the terminal fittings and a lock is provided to engage the lock receiving portion to prevent forward detachment of the front retainer. A retainer-side guiding surface is formed to widen an opening edge of each tab insertion hole for guiding a tab of a mating terminal fitting. The retainer-side guiding surface is at a side that at least partly covers the locking lance from the front when the retainer is assembled. A housing-side guiding surface is formed at an opening edge of each cavity on the front surface of the housing and is widened for guiding the tab. The housing-side guiding surface is formed at positions facing the inside of the tab insertion hole except at a position facing the retainer-side guiding surface when the front retainer is assembled. The lock receiving portion is located behind the housing-side guiding surfaces and includes a part overlapping the retainer-side guiding surfaces in a height direction of the partition wall when the front retainer is assembled.

End edges of the retainer-side guiding surfaces and the housing-side guiding surfaces contact each other when the front retainer is assembled, and are inclined from an inner side toward an outer side in a direction intersecting a width direction. The end edges of the retainer-side guiding surfaces and the housing-side guiding surfaces fit together when the front retainer is assembled to suppress loose movements of the front retainer.

A through hole preferably penetrates the partition wall in forward and backward directions and the lock receiving portion is formed at a rear end opening of the through hole of the partition wall.

The front retainer preferably is formed with a protrusion that projects back and is positioned to be inserted into the through hole. The lock bulges out in a width direction near a rear end of the protrusion.

The disposition of the lock receiving portion at the rear end opening of the through hole of the partition wall simplifies a mold structure for forming the lock receiving portion. Further, the protrusion is fit into the through hole of the partition wall when the front retainer is assembled. Thus, the front holder retainer is positioned in proximity to the retainer-side guiding surfaces and the housing-side guiding surfaces and a variation in relative positions of the retainer-side guiding surfaces and the housing-side guiding surfaces when the front retainer is assembled is suppressed reliably.

The lock receiving portion is behind the housing-side guiding surfaces and overlaps the retainer-side guiding surfaces in the height direction of the partition wall. Thus, a sufficient formation area for the lock receiving portion is ensured and a reduction in a locking margin between the lock and the lock receiving portion is prevented. As a result, holding reliability for the front retainer can be maintained. Further, overlapping of the lock receiving portion and the retainer-side guiding surfaces in the height direction of the partition wall reduces the height of the connector.

These and other objects, features and advantages of the invention will become more apparent upon reading the following detailed description of preferred embodiments and accompanying drawings.

### BRIEF DESCRIPTION OF THE DRAWINGS

FIG. 1 is a plan view in section showing a front retainer held at a partial locking position in a housing of a connector according to one embodiment of the invention.

FIG. 2 is a plan view in section showing the front retainer held at a full locking position in the housing.

FIG. 3 is a side view in section showing the front retainer held at the partial locking position in the housing.

FIG. 4 is a side view in section showing the front retainer is held at the full locking position in the housing.

FIG. 5 is a front view of the connector.

FIG. 6 is a side view in section of the housing.

FIG. 7 is a front view of the housing.

FIG. 8 is a rear view of the housing.

FIG. 9 is an enlarged front view of an essential part of the housing.

FIG. 10 is a side view in section of the front retainer.

FIG. 11 is a plan view in section of the front retainer.

FIG. 12 is a front view of the front retainer.

FIG. 13 is a side view of the front retainer.

### DETAILED DESCRIPTION OF THE PREFERRED EMBODIMENTS

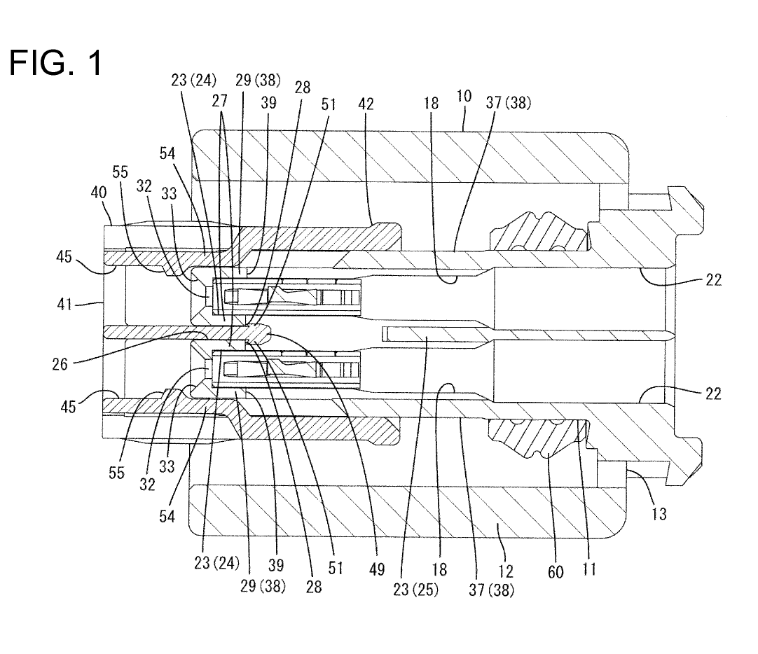

A connector according to an embodiment of the invention is illustrated in FIGS. 1 to 13 and includes a housing 10, a front retainer 40 and terminal fittings 90. The connector is connectable to an unillustrated mating connector. Note that, in the following description, an end to be connected to the mating connector is referred to as the front.

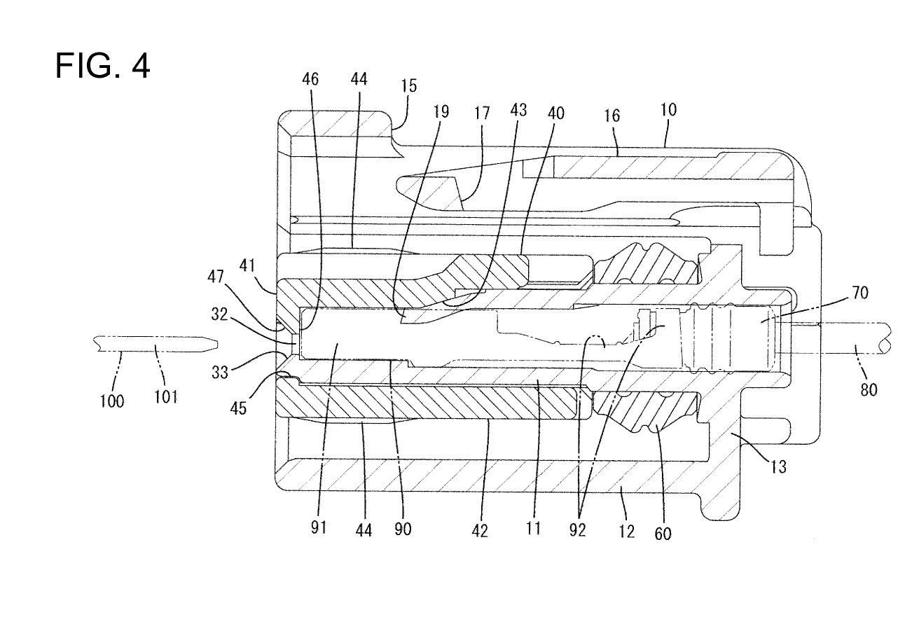

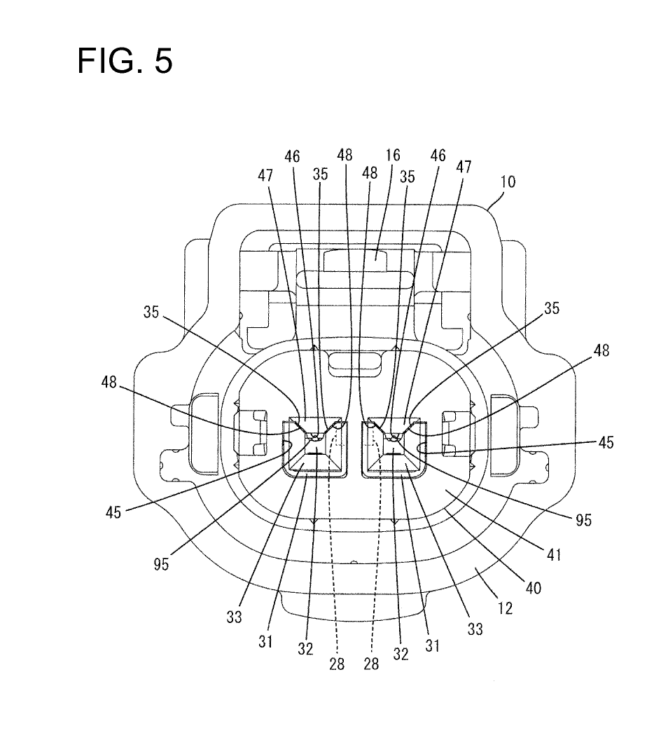

Each terminal fitting 90 is formed by bending, folding and/or embossing an electrically conductive metal plate and, as shown in FIG. 4, includes a box 91 substantially in the form of a tube and a wire connection barrel 92 located behind the box 91. The barrel 92 is crimped and connected to an exposed core at an end of a wire 80 and a rubber plug 70 mounted on the wire 80. The box 91 is formed with an unillustrated lance hole or recess into which a locking lance 19 is to be inserted. A resilient contact piece 95 (see FIG. 5) is formed in the box 91. When the connector is connected to the mating connector, tabs 101 of mating terminal fittings 100 enter the boxes 91 of the terminal fittings 90 from the front and contact the resilient contact pieces 95 for electrically connecting the terminal fittings 90, 100.

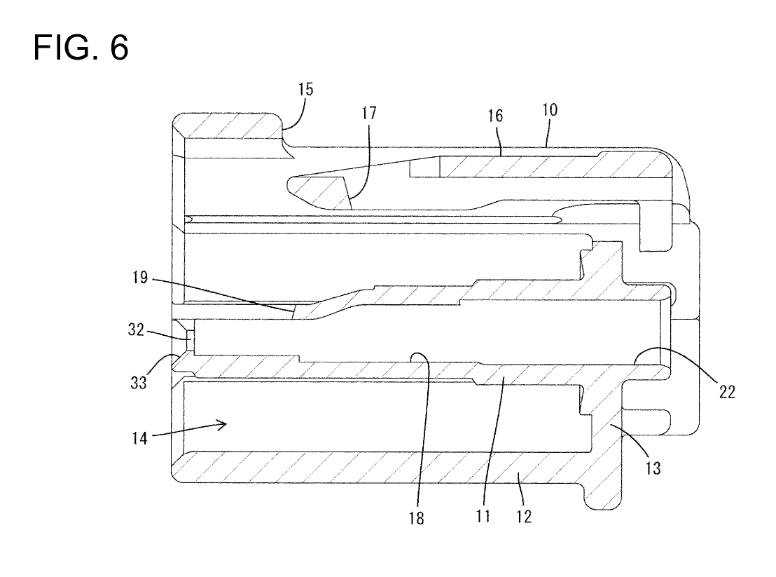

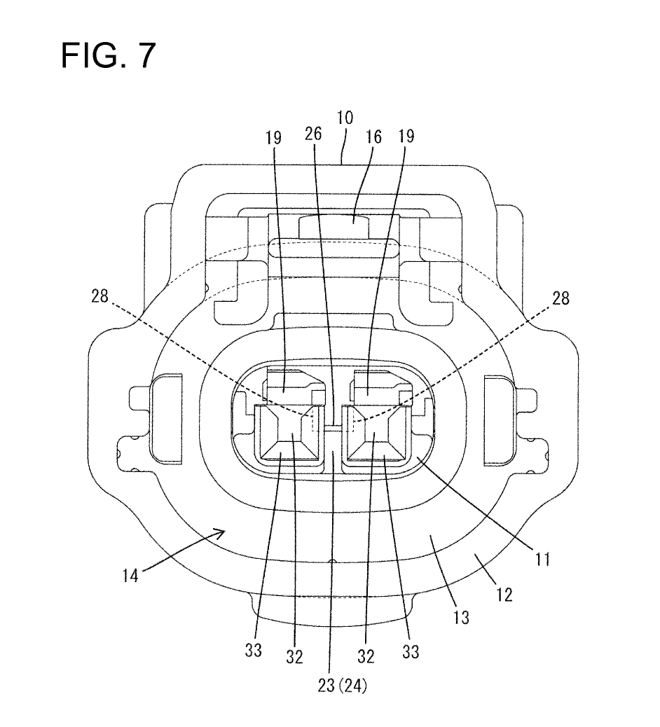

The housing 10 is made e.g. of synthetic resin and includes a substantially block-shaped housing main body 11, a fitting tube 12 at least partly surrounding the housing main body 11, and a coupling 13 coupled to rear ends of the housing main body 11 and the fitting tube 12, as shown in FIGS. 6 and 7. A connection space 14 for an unillustrated receptacle of the mating connector is open forward between the housing main body 11 and the fitting tube 12.

An upper wall of the fitting tube 12 is recessed to form a window 15, as shown in FIG. 6. A lock arm 16 is coupled to the upper surface of the housing main body 11 and can be confirmed visually through the window 15. The lock arm 16 extends in forward and backward directions and is vertically deflectable with a part joined to the housing main body 11 as a support. A rearwardly open lock hole 17 is formed on a front part of the lock arm 16 and extends in forward and backward directions. An unillustrated lock projection of the mating connector is fit into the lock hole 17 when the mating connector is connected to hold the connectors are in a connected state.

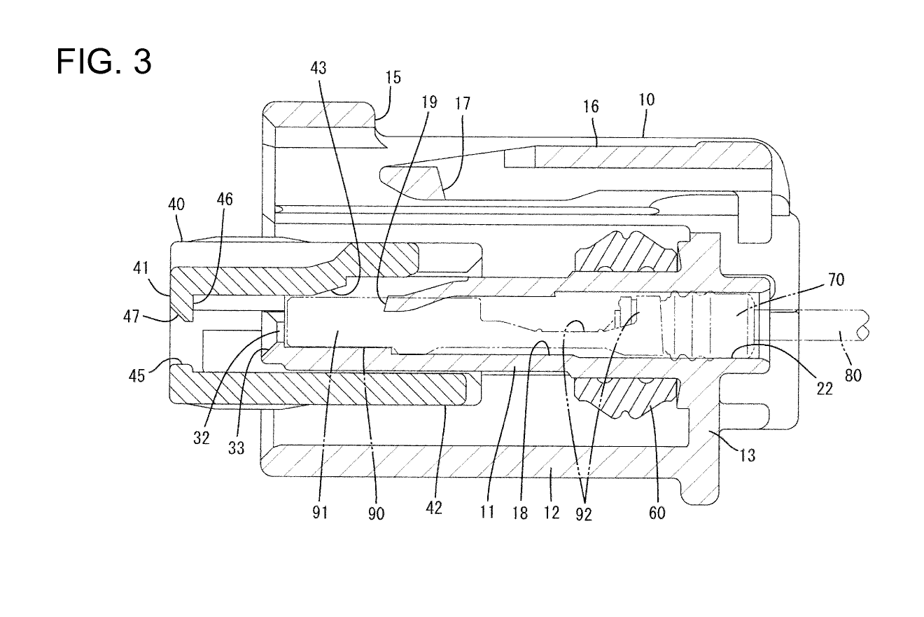

As shown in FIG. 3, a seal ring 60 is mounted before the coupling 13 on the outer peripheral surface of the housing main body 11. The seal ring 60 is compressed resiliently between the receptacle of the mating connector and the housing main body 11, thereby functioning to seal between the connectors in a fluid-tight manner.

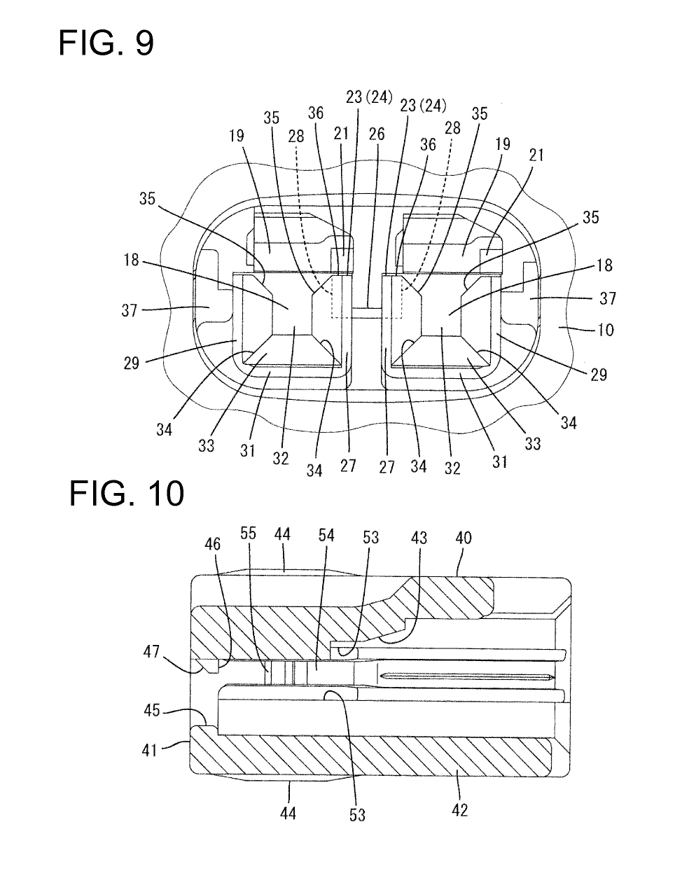

Cavities 18 extend in forward and backward directions through the housing main body 11. As shown in FIG. 9, two cavities 18 are arranged side by side in a width direction. Locking lances 19 are cantilevered forward from inner upper walls of the cavities 18. As shown in FIG. 3, each locking lance 19 inclines gradually down to the front.

The terminal fittings 90 are inserted into the cavities 18 from behind. The front end of the locking lance 19 fits resiliently into the lance hole of the terminal fitting 90 when the terminal fitting 90 is inserted properly into the cavity 18 and retains the terminal fitting 90 in the cavity 18. As shown in FIG. 9, a jig contact surface 21 is formed by cutting on a right end part of the front end of the locking lance 19. The jig contact surface 21 is inclined down toward the back, and a locking state of the locking lance 19 can be released by pressing an unillustrated jig into contact with the jig contact surface 21.

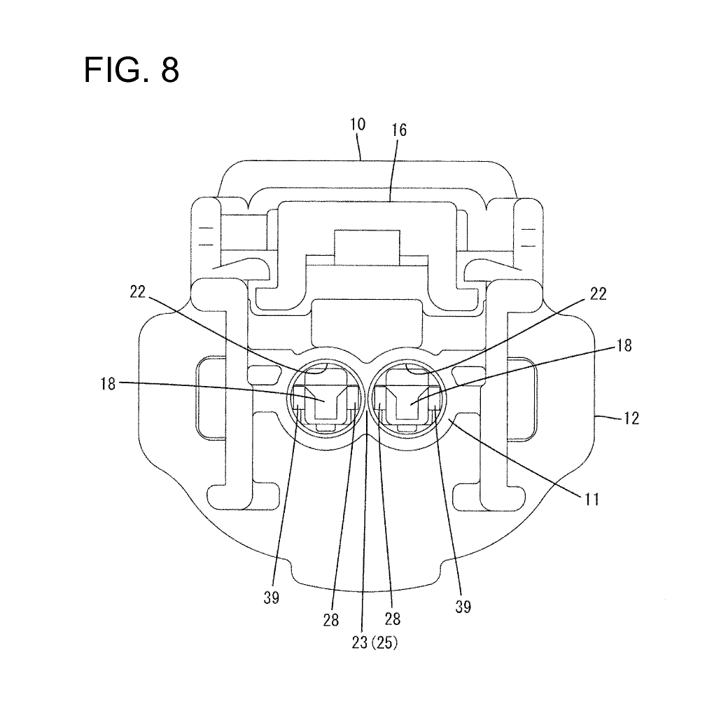

Rubber plug insertion portions 22 with substantially circular cross-sections are formed at rear ends of the cavities 18, as shown in FIG. 8. The rubber plug insertion portions 22 have a larger opening diameter than the front ends of the cavities 18. The rubber plugs 70 are inserted into the rubber plug insertion portions 22 in a fluid-tight manner when the terminal fittings 90 are inserted properly into the cavities 18 and keep the interior of the housing main body 11 fluid-tight.

The housing main body 11 is formed with a partition wall 23 between the adjacent cavities 18, as shown in FIG. 1. The partition wall 23 comprises a front partition wall 24 near a front end and a rear partition wall 25 near a rear end. The front partition wall 24 is at the front end of the housing main body 11 and extends a short distance in forward and backward directions. The rear partition wall 25 is at the rear end of the housing main body 11 and extends a long distance in forward and backward directions. A clearance extends in forward and backward directions between the front and rear partition walls 24, 25, and the front ends of the locking lances 19 face the clearance from above.

As shown in FIG. 9, the upper end of the front partition wall 24 is exposed at a position slightly lower than the lower or opposite lateral ends of the locking lances 19. A through hole 26 is formed in a widthwise central part of the front partition wall 24. The through hole 26 extends in forward and backward directions and is open on both front and rear ends of the front partition wall 24 (see FIG. 1) and is open on the upper end of the front partition wall 24 to define a substantially U-shaped cross-section (see FIG. 9). Inner walls 27 stand on opposite lateral sides of the through hole 26, on the front partition wall 24. As shown in FIG. 1, two laterally spaced partial lock receiving portions 28 are formed on the rear ends of the inner walls 27 and at a rear end of the through hole 26.

As shown in FIG. 1, the through hole 26 is at a position substantially coaxial with the rear partition wall 25 in forward and backward directions and has an opening width substantially equal to the thickness of the rear partition wall 25. The inner walls 27 do not overlap the rear partition wall 25 in the width direction. Thus, the partial lock receiving portions 28 of the inner walls 27 are open to the rear end of the housing main body 11 and can be visually confirmed through the rubber plug insertion portions 22 from behind.

As shown in FIG. 9, the front end of the cavities 18 in the housing main body 11 is defined by the inner wall 27, an outer wall 29 located at an outer side to face the inner wall 27, and a lower wall 31 coupled to lower ends of the inner wall 27 and the outer wall 29. A tab through hole 32 penetrates in forward and backward directions and has an open upper end formed at an inner side thereof. A front end of the box 91 of the terminal fitting 90 can be fit into a rear part of an area defined by the inner wall 27, the outer wall 29 and the lower wall 31.

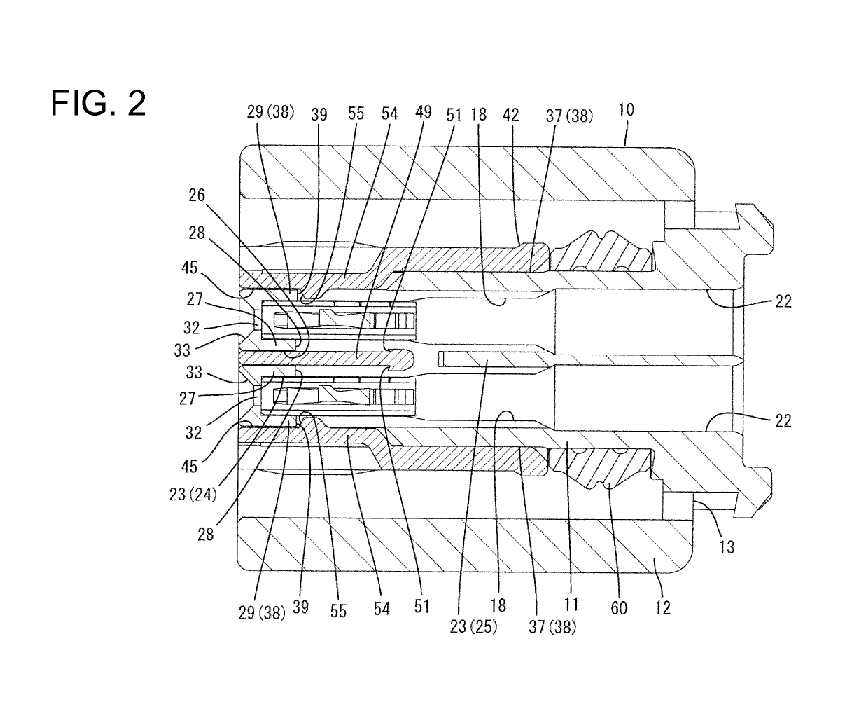

Housing-side guiding surfaces 33 are formed on the front surface of the housing main body 11 to gradually widen an opening of each tab through hole 32 to the front, as shown in FIG. 2. The housing-side guiding surface 33 is arranged along the width direction on the front surface of the lower wall 31 and along a height direction on the front surfaces of the inner and outer walls 27 and 29, as shown in FIG. 9. Boundary lines 34 are formed on parts of the housing-side guiding surface 33 where lateral ends of the front surface of the lower wall 31 are coupled to the inner and outer walls 27 and 29 and are inclined from an inner side at the tab through hole 32 to an outer lower side to intersect with the width direction. Housing-side facing lines 35 are formed on parts of the housing-side guiding surface 33 located on upper ends of the inner wall 27 and the outer wall 29 and are inclined from the inner side at the tab through hole 32 to an outer upper side to intersect with the width direction.

The housing-side facing line portions 35 and the through hole 26 are coupled by straight portions 36 extending along the width direction, as shown in FIG. 9. Further, the partial lock receiving portions 28 described above overlap the straight portions 36 in the width direction and overlap the housing-side facing line portions 35 in the height direction.

As shown in FIG. 1, the outer walls 29 extend a short distance in forward and backward directions and together with rear side walls 37 located behind the outer walls 29 form the side walls 38 of the housing main body 11. The outer wall 29 and the inner wall 27 are substantially symmetrical with respect to a widthwise center of the cavity 18. As shown in FIG. 2, two full lock receiving portions 39 are formed on the rear ends of the outer walls 29 while being spaced apart in the width direction. The full lock receiving portions 39 are arranged at the same positions as the partial lock receiving portions 28 in forward and backward directions and the height direction. The full lock receiving portions 39, like the partial lock receiving portions 28, are open to the rear end of the housing main body 11 and can be visually confirmed from behind through the rubber plug insertion portions 22 of the cavities 18. Thus, entire areas of backward projection of the full lock receiving portions 39 and the partial lock receiving portions 28 are located inside the rubber plug insertion portions 22 as shown in FIG. 8. Thus, the rubber plug insertion portions 22 are formed so that the inner surfaces have substantially have a circular cross-section and predetermined sealability can be ensured for the rubber plugs 70 without being affected by the presence of the full lock receiving portions 39 and the partial lock receiving portions 28 located in front.

As shown in FIG. 1, the rear side walls 37 are located outward of the outer walls 29 in the width direction. Rear end parts of the rear side walls 37 are connected to the coupling portion 13 and the seal ring 60 is mounted on the outer peripheral surfaces of the rear end sides of the rear side walls 37. Clearances extend in forward and backward directions between the rear side walls 37 and the outer walls 29. Note that the rear side walls 37 are thicker than the outer walls 29 and the front ends of the rear side walls 37 are cut obliquely to widen gradually toward the outer side.

The front retainer 40 is made e.g. of synthetic resin and, as shown in FIGS. 10 to 13, includes a front wall 41 extending along the height direction and a tubular peripheral wall 42 projects back from the outer peripheral edge of the front wall 41. Two retaining portions 43 project in on an upper part of the peripheral wall 42 while being spaced apart in the width direction.

The front retainer 40 is assembled with the housing main body 11 from the front. The front retainer 40 is movable in forward and backward directions to a partial locking position (see FIGS. 1 and 3) where the front wall 41 is separated from the front surface of the housing main body 11 and the retaining portions 43 are retracted forward from the deformation spaces for the locking lances 19 and a full locking position (see FIGS. 2 and 4) where the front wall 41 substantially contacts the front surface of the housing main body 11 and the retaining portions 43 are located in the deformation spaces for the locking lances 19.

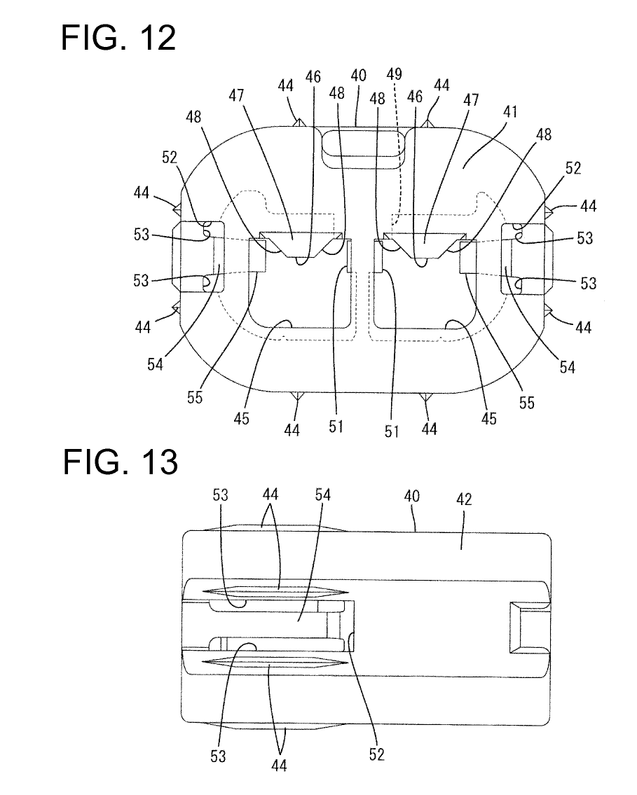

As shown in FIG. 12, the peripheral wall 42 is formed with rattling-preventing projections 44 spaced apart in a circumferential direction. Each rattling-preventing projection 44 is in the form of a rib extending in forward and backward directions and two rattling-preventing projections 44 are arranged on each of an upper part, a lower part and opposite side parts of the peripheral wall 42. When the receptacle of the mating connector is fit into the connection space 14 of the housing 10, the respective rattling-preventing projections 44 are compressed and squeezed by the receptacle to prevent rattling of the mating connector with respect to the housing 10.

As shown in FIG. 12, the front wall 41 has two penetrating tab insertion holes 45. The housing-side guiding surfaces 33 are arranged to face the insides of the tab insertion holes 45 when the front retainer 40 reaches the full locking position, as shown in FIGS. 4 and 5.

As shown in FIG. 12, an upper wall 46 of isosceles trapezoidal cross-section project down on an upper side of each tab insertion hole 45 of the front wall 41. As shown in FIG. 4, the upper wall 46 is arranged to cover the locking lance 19 from front when the front retainer is assembled, and a retainer-side guiding surface 47 is formed on the front surface thereof. The retainer-side guiding surface 47 is inclined out toward the front surface of the front wall 41. Further, as show in FIG. 12, two retainer-side facing lines 48 are formed on opposite left and right ends of the retainer-side guiding surface 47. The retainer-side facing lines 48 are inclined to become wider apart from an inner side at the tab insertion hole 45 to an outer upper side and to intersect with the width direction.

When the front retainer 40 reaches the full locking position, the upper walls 46 face the lower walls 31 while being spaced apart in the height direction and the retainer-side facing line portions 48 are arranged to face and contact the housing-side facing lines 35, as shown in FIG. 5. The retainer-side guiding surfaces 47 and the housing-side guiding surfaces 33 are connected in the circumferential direction and upper sides of the tab through holes 32 are closed by the upper walls 46. When the front retainer 40 is assembled, the retainer-side guiding surfaces 47 and the partial lock receiving portions 28 partly overlap each other in the height direction.

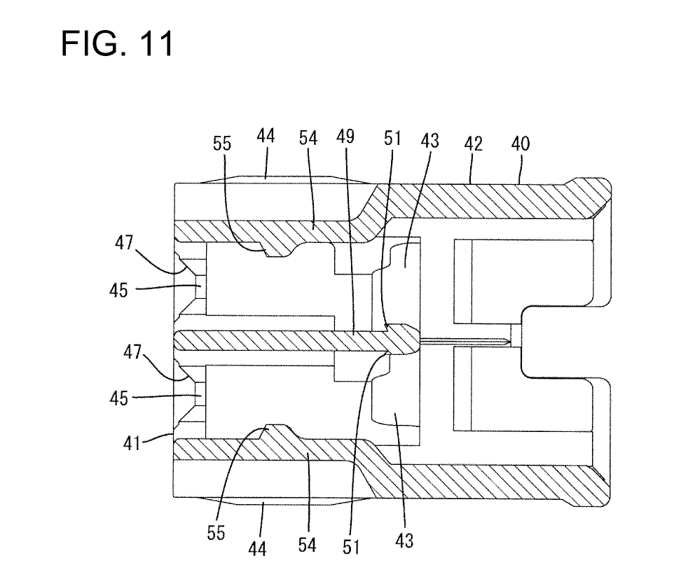

As shown in FIG. 11, a protrusion 49 substantially projects back from a part of the front wall 41 that partitions the tab insertion holes 45. The partition is coupled unitarily in forward and backward directions to a section between the both retaining portions 43 in the upper part of the peripheral wall 42. Two partial locks 51 bulge out laterally on a rear part of the protrusion 49. One of the partial locks 51 bulges out more than the other.

The protrusion 49 enters the through hole 26 and the partial locks 51 face the rear ends of the inner walls 27 to engage the partial lock receiving portions 28 when the front retainer 40 reaches the partial locking position, as shown in FIG. 1. Thus, the front retainer 40 cannot be detached forward from the housing 10.

Two recesses 52 are formed by recessing opposite side parts of the peripheral wall 42 at intermediate positions in the height direction, as shown in FIG. 12. The recesses 52 are arranged in specified ranges extending back from the front end of the peripheral wall portion 42 between the upper and lower rattling-preventing projections.

Upper and lower slits 53 are formed in each of the recesses 52, of the peripheral wall portion 42. As shown in FIG. 13, the respective slits 53 extend in forward and backward directions and are parallel to each other. A locking arm 54 is formed between the upper and lower slits 53 in each recess 52 of the peripheral wall 42. As shown in FIG. 11, the locking arms 54 are supported at both front and rear ends extend straight back from the front ends thereof. Each locking arm 54 has a widened rear end and an oblique front end. Full locking portions 55 project in on the inner surfaces of the full locking portions 54. The full locking portions 55 are at intermediate positions of the locking arms 54 before the partial locking portions 51 in forward and backward directions.

As shown in FIG. 2, when the front retainer 40 reaches the full locking position, the full locking portions 55 face the rear ends of the outer walls 29 and engage the full locking portions 39 after the locking arms 54 are deflected. This prevents the front retainer 40 at the full locking position from being detached from the housing 10.

The front retainer 40 is assembled at the partial locking position in the housing main body 11. At the partial locking position, the protrusion 49 penetrates through the through hole 26 of the front partition wall 24 and the partial locks 51 engage the partial lock receiving portions 28, as shown in FIG. 1, to prevent forward detachment of the front retainer 40. The full locking portions 55 contact the front ends of the outer walls 29 of the housing main body 11 to restrict a backward movement of the front retainer 40 toward the full locking position. The protrusion 49 of the front retainer 40 is fit into the through hole 26 and the partial locks 51 and the partial lock receiving portions 28 engage in proximity to that fitted position. Thus, the partial locks 51 and the partial lock receiving portions 28 reliably engage while ensuring a specified locking margin.

The connector may be transported to a harness manufacturing site with the front retainer 40 at the partial locking position. At the manufacturing site, the terminal fittings 90 are inserted into the cavities 18 of the housing main body 11 from behind. The properly inserted terminal fittings 90 are locked resiliently primarily by the locking lances 19. Subsequently, the front retainer 40 is pushed toward the full locking position. The front ends of the outer walls 29 and the full locking portions 55 are disengaged to permit the front retainer 40 to move to the full locking position. The full locking portions 55 slide along the outer surfaces of the outer walls 29 and the locking arms 54 move resiliently out and away from each other in the process of moving the front retainer 40 to the full locking position. The locking arms 54 resiliently return when the full locking position is reached, as shown in FIG. 2 and the full locking portions 55 engage the full lock receiving portions 39 to prevent forward detachment of the front retainer 40. Further, the front wall 41 contacts the front surface of the housing main body 11 to restrict further backward movement of the front retainer 40. Further, at the full locking position, the retaining portions 43 are in the deformation spaces for the locking lances 19 to restrict deflection of the locking lances 19 as shown in FIG. 4, so that the terminal fittings 90 are locked secondarily.

As shown in FIG. 5, when the front retainer 40 reaches the full locking position, the housing-side guiding surfaces 33 face the insides of the tab insertion holes 45 and the housing-side guiding surfaces 33 and the retainer-side guiding surfaces 47 are fit to each other to surround the tab through holes 32 over the entire periphery. Thus, if the connector is connected to the mating connector thereafter, the tabs 101 of the mating terminal fittings 100 are guided smoothly into the respective cavities 18 along the housing-side guiding surfaces 33 and the retainer-side guiding surfaces 47 to correct connecting postures of the tabs 101 with respect to the terminal fittings 90.

As described above, the partial lock receiving portions 28 are formed at the rear end opening of the through hole 26 of the front partition wall 24. Thus, a mold structure for forming the partial lock receiving portions 28 does not become particularly complicated and moldability is good. Further, the full lock receiving portions 39 are paired with the side walls 38 different from the front partition wall 24. Hence, sufficient locking margins for the full locking portions 55 is ensured and holding reliability of the front retainer 40 is improved.

The partial lock receiving portions 28 are open to the rear surface of the housing 10 and can be formed easily together with the respective cavities 18 by pulling a mold backward. In addition, the full lock receiving portions 39 also are open to the rear surface of the housing 10. Thus, the full lock receiving portions 39, the partial lock receiving portions 28 and the respective cavities 18 can be formed at once by one mold. Furthermore, the entire areas of backward projection of the full lock receiving portions 39 are located inside the rubber plug insertion portions 22. Therefore, the rubber plug insertion portions 22 can be formed by the mold for forming the full lock receiving portions 39. Furthermore, molding marks of the full lock receiving portions 39 are not left on the inner surfaces of the rubber plug insertion portions 22, the inner surfaces of the rubber plug insertion portions 22 can fulfill proper sealing performance as sealing surfaces.

The partial lock receiving portions 28 are behind the housing-side guiding surfaces 33 and overlap the retainer-side guiding surfaces 47 in the height direction. Thus, sufficient formation areas for the partial lock receiving portions 28 are ensured and the locking margins between the partial locking portions 51 and the partial lock receiving portions 28 is large. As a result, holding reliability for the front retainer 40 is maintained. Further, the overlap of the partial lock receiving portions 28 and the retainer-side guiding surfaces 47 in the height direction reduces the height of the connector.

Further, the housing-side facing line portions 35 and the retainer-side facing line portions 48 are inclined from the inner side to the outer side in directions to intersect with the width direction. Thus, the housing-side facing line portions 35 and the retainer-side facing line portions 48 are fit to each other when the front retainer 40 is assembled to suppress loose movements of the front retainer 40 in the width direction.

The protrusion 49 is fit into the through hole 26 of the front partition wall 24 when the front retainer 40 is assembled so that the front retainer is positioned with respect to the housing 10 in proximity to the retainer-side guiding surfaces 47 and the housing-side guiding surfaces 33. Thus, a variation in relative positions of the retainer-side guiding surfaces 47 and the housing-side guiding surfaces 33 is prevented reliably when the front retainer 40 is assembled.

The invention is not limited to the above described embodiment. For example, the following embodiments also are included in the scope of the invention.

The partial locking portion may bulge to one widthwise side from the rear of the protrusion and the partial lock receiving portion may be only on one side corresponding to the partial locking portion at the rear of the through hole in the partition wall.

The housing main body may have three or more cavities arranged side by side. Partition walls may be formed between the respective cavities, and through holes may be formed on the partition walls. The retainer may have a plurality of protrusions.

A cut groove may extend in forward and backward directions on the rear end of the protrusion, and the rear end of the protrusion may be narrowed resiliently via the cut groove when the partial locking portions pass through the through hole. By doing so, insertion resistance in inserting the protrusion into the through hole is reduced.

The protrusion may be coupled to the peripheral wall instead of being coupled to the front wall.

What is claimed is:

1. A connector, comprising:
a housing (10) including cavities (18) for receiving terminal fittings (90), locking lances (19) projecting from inner surfaces of the respective cavities (18) for primarily retaining the terminal fittings (90), and a lock receiving portion (28) on a partition wall (23) partitioning between adjacent cavities (18); and
a front retainer (40) assembled with the housing (10) and including a front wall (41) configured to at least partly cover the front surface of the housing (10) and formed with tab insertion holes (45) penetrating at positions facing the respective cavities (18), retaining portions (43) located behind the front wall (41) for secondarily retaining the terminal fittings (90) and a lock (51) to be engaged with the lock receiving portion (28) to prevent forward detachment of the front retainer (40);
wherein:
a retainer-side guiding surface (47) at one side of an opening of each tab insertion hole (45) and at least partly covering the locking lance (19) from front when the retainer (40) is assembled, the retainer-side guiding surface (47) be widened for guiding a tab (101) of a mating terminal fitting (100);
a housing-side guiding surface (33) formed at an opening of each cavity (18) on the front surface of the housing (10) facing an inside of the tab insertion hole (45) except at the one side when the front retainer (40) is assembled, the housing-side guiding surface (33) being widened for guiding the tab (101); and
the lock receiving portion (28) is located behind the housing-side guiding surfaces (33) and includes a part overlapping the retainer-side guiding surfaces (47) in a height direction of the partition wall (23) when the front retainer (40) is assembled.

2. The connector of claim 1, wherein end edges of the retainer-side guiding surfaces (47) and the housing-side guiding surfaces (33) face and contact each other when the front retainer (40) is assembled, and are inclined from an inner side toward an outer side in a direction to intersect with a width direction.

3. The connector of claim 1, wherein a through hole (26) penetrates the partition wall (23) in forward and backward directions and the lock receiving portion (28) is formed at a rear end opening of the through hole (26) of the partition wall (23).

4. The connector of claim 3, wherein the front retainer (40) has a rearward projecting protrusion (49) positioned to be at least partly inserted into the through hole (26), and the lock (51) bulges out substantially in a width direction on a rear part of the protrusion (49).

5. The connector of claim 1, wherein the partial lock receiving portions (28) are open to the rear surface of the housing (10).

6. The connector of claim 5, wherein the partial lock receiving portion (28) is located behind the housing-side guiding surface (33) and includes parts overlapping the retainer-side guiding surface (47) in the height direction.

7. A connector, comprising:
a housing (10) with opposite front and rear ends, first and second cavities (18) extending from the rear end toward the front end, first and second tab holes (32) extending from the front end of the housing (10) and into the respective first and second cavities (18), housing-side guiding surface (33) extending partly around the respective tab holes (32), first and second inner walls (27) between the cavities (18) and facing into the respective first and second cavities (18), rearwardly facing first and second lock receiving surfaces (28) on rear ends of the respective first and second inner walls (27), a forwardly open through hole (26) between the first and second inner walls (27) and first and second locking lances (19) cantilevered forward from inner surfaces of the respective first and second cavities (18); and
a front retainer (40) assembled with the housing (10) and including a front wall (41), first and second tab insertion holes (45) penetrating the front wall (41) at positions facing the respective first and second tab holes (32), first and second retaining portions (43) projecting rearward from the front wall and engaging the respective first and second locking lances (19), a protrusion (49) projecting rearward from the front wall and into the through hole (26), locks (51) formed on the protrusion (49) and engageable with the lock receiving portion (28) to prevent forward detachment of the front retainer (40) from the housing (10) at a partial locking position, and first and second retainer-side guiding surfaces (47) at a side of each respective first and second tab insertion holes (45) and at least partly covering the locking lances (19) from the front when the retainer (40) is assembled, the retainer-side guiding surface (47) overlapping the lock receiving portion (28) in a height direction.

8. The connector of claim 7, wherein end edges of the retainer-side guiding surfaces (47) and the housing-side guiding surfaces (33) face and contact each other when the front retainer (40) is assembled, and are inclined from an inner side toward an outer side in a direction to intersect with a width direction.

9. The connector of claim 7, wherein the housing (10) further comprises first and second outer walls (29) facing into the respective first and second cavities (18), first and second full lock receiving portions (39) formed on rear ends of the respective first and second outer walls (29), and wherein the front retainer (40) has first and second full locking portions (55) engageable with the respective first and second full lock receiving portions (39) when the front retainer is in a full locking position on the housing (10).

10. The connector of claim 10, wherein the first and second lock receiving surfaces (28) and the first and second full lock receiving portions (39) face rearward into open rear ends of the respective first and second cavities (18).
